(19) United States
(12) Patent Application Publication
(10) Pub. No.: US 2011/0149968 A1
(43) Pub. Date: Jun. 23, 2011

(54) METHOD FOR CONTROLLING INTERNET NETWORK

(75) Inventor: Young Hwa KIM, Daejeon (KR)

(73) Assignee: Electronics and Telecommunications Research Institute, Daejeon (KR)

(21) Appl. No.: 12/974,600

(22) Filed: Dec. 21, 2010

(30) Foreign Application Priority Data
Dec. 21, 2009 (KR) 10-2009-0127989
Dec. 2, 2010 (KR) 10-2010-0121883

(51) Int. Cl. H04L 12/56

(52) U.S. Cl. 370/392

(57) ABSTRACT

An Internet network control method is disclosed. When an inter-layer interworking occurs in the Internet network, an upper layer transmits control information on layers related to the interworking to the layers. Therefore, a uniform system for packet exchange in the Internet network is provided. Additionally, since a packet header of a packet transmitted among the layers includes an identifier (ID) regarding a slice, information may be distributed in a centralized system or a distributed system.

### CROSS-REFERENCE TO RELATED APPLICATION

This application claims the benefit of Korean Patent Application Nos. 10-2009-0127989 and 10-2010-0121883, respectively filed on Dec. 21, 2009 and Dec. 2, 2010, in the Korean Intellectual Property Office, the disclosures of which are incorporated herein by reference.

### BACKGROUND

1. Field of the Invention

The present invention relates to a method for controlling an Internet network.

2. Description of the Related Art

Recently, the future Internet is being actively studied to develop the Internet to overcome limits of the present Internet technology. Organizations and projects for research regarding the future Internet, such as Global Environment for Network Innovation(GENI), Future Internet Research and Experimentation(FIRE), and the like, are now active around the U.S. and Europe. Also, domestically, a future Internet testbed is under construction in Korea.

GENI refers to a project in progress in the U.S. regarding the future Internet. GENI aims at constructing a national network infrastructure capable of being maintained for a long time and of providing an almost real environment, and constructing a network infrastructure for various fields including science and engineering.

FIRE refers to a future Internet project in progress in Europe. FIRE aims at developing future Internet technologies of the future Internet in a framework program (FP7) and constructing an infrastructure for various experiments.

Researches for a network virtualization technology related to the future Internet are actively being performed. The network virtualization technology provides a variety of logical networks desired by users on a single physical network. Such logical networks may be virtual networks. With regard to the future Internet, a slice may be a network function operated on the virtual network. A sliver may be a function by which the slice is practically operated on a node.

Control information is used when various architectures and services of the Internet are carried out in the physical Internet network. The control information may include performance of a packet, a virtual network including the packet, a virtual node related to the packet, a sliver related to the packet, and a virtual interface related to the packet.

For example, according to GENI, a packet structure provisionally includes a sliver identifier (SliverID) and a virtual interface ID (VirlFID). However, different from a slice ID (SliceID), the SliverID and the VirIFID are the control information to be managed substantially by each node. Information subjected to the node, such as the SliverID and the VirIFID, are capable of mutual communication among the nodes only when distributed by a centralized system or a distributed system.

Accordingly, a new method to control the Internet network is desired.

### SUMMARY

According to an aspect of the present invention, there is provided a method for controlling an Internet network divided into a plurality of layers, the method including transmitting control information on a plurality of first layers out of the plurality of layers, the first layers related to an interworking, to the plurality of first layers from an upper layer of the first layers when the interworking occurs between the plurality of first layers.

According to another aspect of the present invention, there is provided a method for transmitting a packet in an Internet network, including inputting an ID related to a slice of the Internet network to a packet header of the packet.

### EFFECT

According to embodiments of the present invention, when an inter-layer interworking occurs in an Internet network, an upper layer transmits control information on a layer related to the interworking to the layers. Therefore, the suggested Internet network provides a uniform system for packet exchange in the Internet network.

Additionally, according to embodiments of the present invention, since a packet header of a packet transmitted among the layers includes an identifier (ID) regarding a slice, information may be distributed in a centralized system or a distributed system.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an Internet network according to an embodiment of the present invention;

FIG. 2 is a flowchart illustrating a flow of a message in an Internet network according to an embodiment of the present invention;

FIG. 3 is a flowchart illustrating a method to control an Internet network according to an embodiment of the present invention;

FIG. 4 is a diagram illustrating a hierarchical structure of an Internet network according to an embodiment of the present invention;

FIG. 5 is a diagram illustrating a hierarchical structure of an Internet network according to another embodiment of the present invention;

FIG. 6 is a diagram illustrating a structure of a conventional packet; and

FIG. 7 is a diagram illustrating a structure of a packet according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

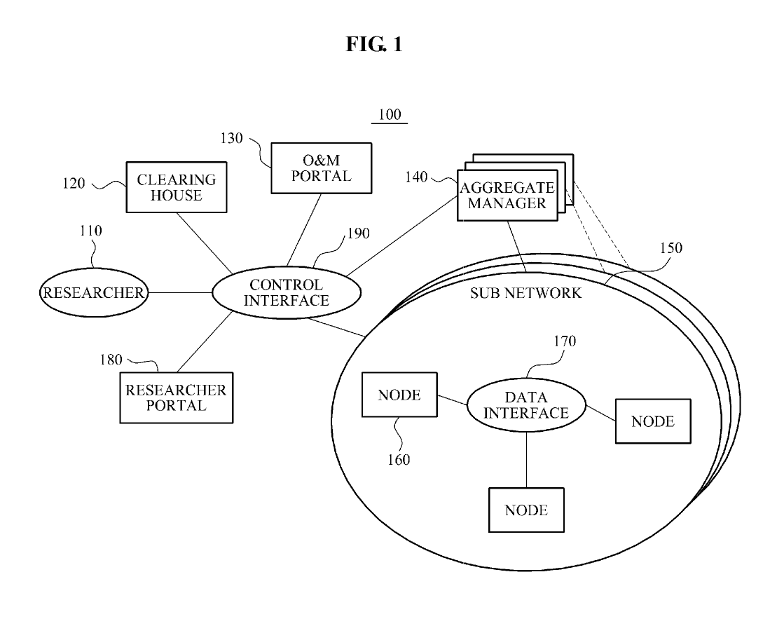

FIG. 1 is a diagram illustrating an Internet network 100 according to an embodiment of the present invention.

A clearing house 120 may function as an information center that manages information, registry, database, and the like to share resources and generate slices on the Internet network 100. The clearing house 120 may authenticate and authorize a researcher 110 of the Internet. Additionally, the clearing house 120 may manage slices, component registries, and the like, and also manage policies and portals for finding resources.

The slice may refer to a virtual network generated on the Internet network 100 to perform a service defined by the researcher 110.

The sliver may refer to various levels of application by the researcher 110 with respect to the Internet network 100.

An operation and management portal (O&M portal) 130 may refer to a portal to operate and manage the Internet network 100. The researcher 110 may connect to the O&M portal 130 and thereby acquire information on the operation and management states of the Internet network 100.

An aggregate manager 140 may manage a sub network 150 included in the Internet network 100. The sub network 150 may include a plurality of nodes 160. The nodes 160 may download and execute programs of the researcher 110. Depending on embodiments, the nodes 160 may function as a component manager. A data interface 170 may refer to a physical interface on a data plane interconnecting the plurality of nodes 160.

A researcher portal 180 may refer to a portal of a group to which the researcher 110 belongs to. The researcher portal 180 may manage a project carried out by the group including the researcher 110 with respect to the Internet network 100.

A control interface 190 may refer to an interface to perform control and management in the clearing house 120, the O&M portal 130, the aggregate manager 140, the plurality of nodes 160 of the sub network 150, and the researcher portal 180.

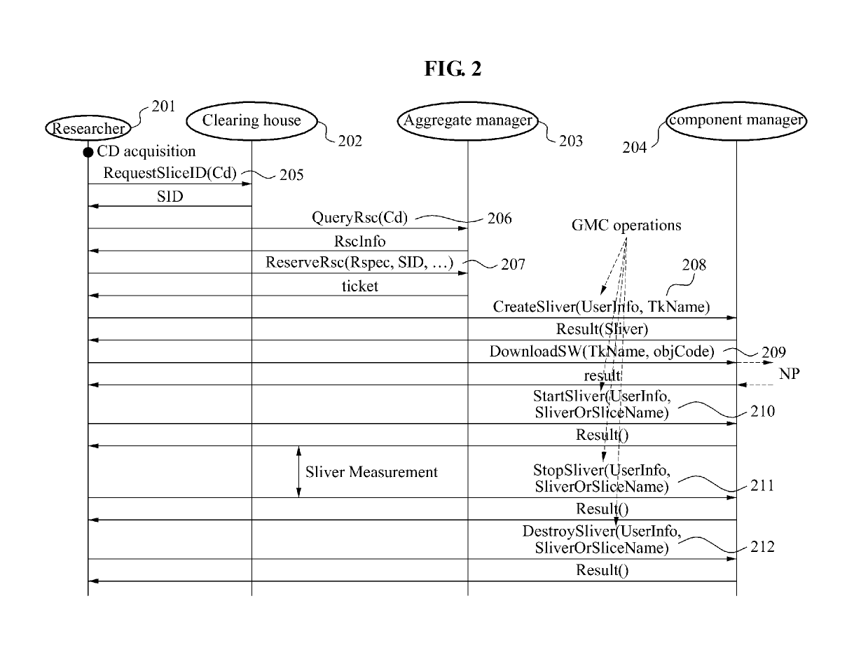

FIG. 2 is a flowchart illustrating flow of a message in an Internet network according to an embodiment of the present invention.

Referring to FIG. 2, a researcher 201 of the Internet network according to the embodiment may acquire a credential (CD) and then transmit a request slice identifier (ID) message to a clearing house 202 in operation 205. The request slice ID message may include the CD. The clearing house 202 may respond to a request of the researcher (201) by transmitting a slice ID (SliceID) to the researcher 201.

The researcher 201 may transmit a query resource (QueryRsc) message to an aggregate manager 203 in operation 206. A QueryRsc message may include a CD. The aggregate manager 203 may transmit a resource information (RscInfo) message to the researcher 201 in response to the QueryRsc message.

The researcher 201 may transmit a reserve resource message to the aggregate manager 203 in operation 207. The reserve resource message may include a resource specification and SliceID.

The resource specification may refer to a specification describing resources on the Internet network. Depending on embodiments, the resource specification may describe a specification of the resource, a request for the reserve resource, details regarding the reserve resource, relations among the resources, and the like. In addition, the resource specification may be expressed by an eXtensible Markup Language (XML) schema.

The aggregate manager 203 may transmit a ticket message to the researcher 201 in response to the reserve resource message.

The researcher 201 may transmit a create sliver request message to a component manager 204 in operation 208. The create sliver request message may include information on the researcher 201 (UserInfo), a ticket name (TkName), and the like.

The component manager 204 may transmit a result message to the researcher 201 in response to the create sliver request message. The result message may include information on the sliver.

The researcher 201 may transmit a download software (DownloadSW) request message to the component manager 204 in operation 209. The DownloadSW request message may include TkName and an object code (objCode). The objCode may be a program source or an object program. The component manager 204 may transmit a result message to the researcher 201 in response to the DownloadSW request message.

The researcher 201 may transmit a start sliver request message to the component manager 204 in operation 210. The start sliver request message may include UserInfo, and a sliver name or slice name. The component manager 204 may transmit a result message to the researcher 201 in response to the start sliver request message.

The researcher 201 may transmit a stop sliver request message to the component manager 204 in operation 211. The stop sliver request message may include Userinfo, and the sliver name or slice name. The component manager 204 may transmit a result message to the researcher 201 in response to the stop sliver request message.

The researcher 201 may transmit a destroy sliver request message to the component manager 204 in operation 212. The destroy sliver request message may include Userinfo, and the sliver name or slice name. The component manager 204 may transmit a result message to the researcher 201 in response to the destroy sliver request message.

Depending on embodiments, the researcher 201 may transmit at least one of a list sliver request message and a list slice request message to the component manager 204. In case of receiving the list sliver request message, the component manager 204 may transmit a result message regarding the list sliver to the researcher 201. In case of receiving the list slice request message, the component manager 204 may transmit a result message regarding the list slice to the researcher 201.

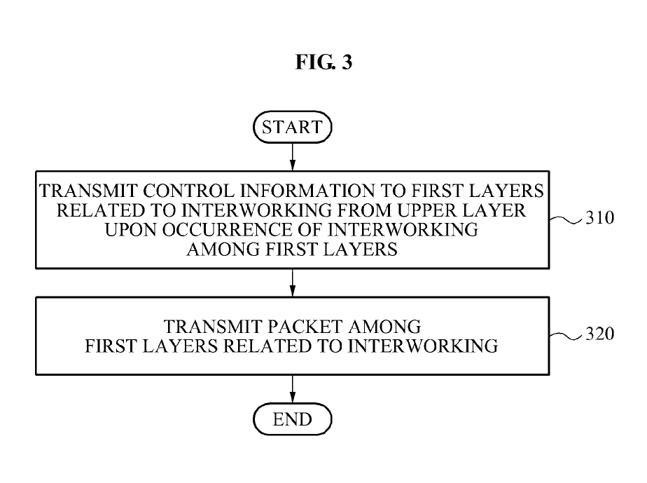

FIG. 3 is a flowchart illustrating a method to control an Internet network according to an embodiment of the present invention.

Referring to FIG. 3, according to the method to control the Internet network divided into a plurality of layers, when an interworking occurs among first layers out of the plurality of layers, an upper layer of the first layers may transmit the control information on a plurality of the first layers related to the interworking to the plurality of first layers in operation 310.

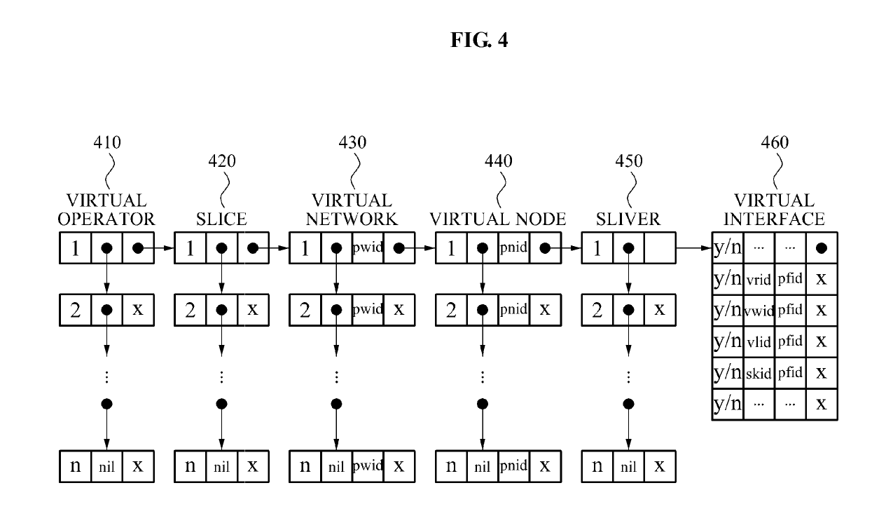

According to an aspect of the present invention, the plurality of layers of the Internet network may include a virtual operator, a slice, a virtual network, a virtual node, a virtual interface, and a sliver. The layers of the Internet network according to an embodiment will be described in further detail with reference to FIG. 4.

In a case where data is transmitted and received among layers, the inter-layer interworking may occur when the plurality of layers are collectively processed to perform a single service.

The control information may include at least one selected from a virtual operator ID related to the virtual operator of the Internet network, a slice ID related to the slice of the Internet network, a virtual network ID related to the virtual network of the Internet network, a virtual node ID related to the virtual node of the Internet network, a virtual interface ID related to the virtual interface of the Internet network, and a sliver ID related to the sliver of the Internet network.

Depending on embodiments, an interworking may occur among virtual network layers out of the plurality of layers of the Internet network. When the interworking occurs between a first virtual network and a second virtual network of the virtual network layers, a slice layer which is an upper layer of the virtual network layer may transmit the control information on the first virtual network and the second virtual network to the first virtual network and the second virtual network, respectively. Here, the control information may include the virtual network ID related to the first virtual network and the virtual network ID related to the second virtual network.

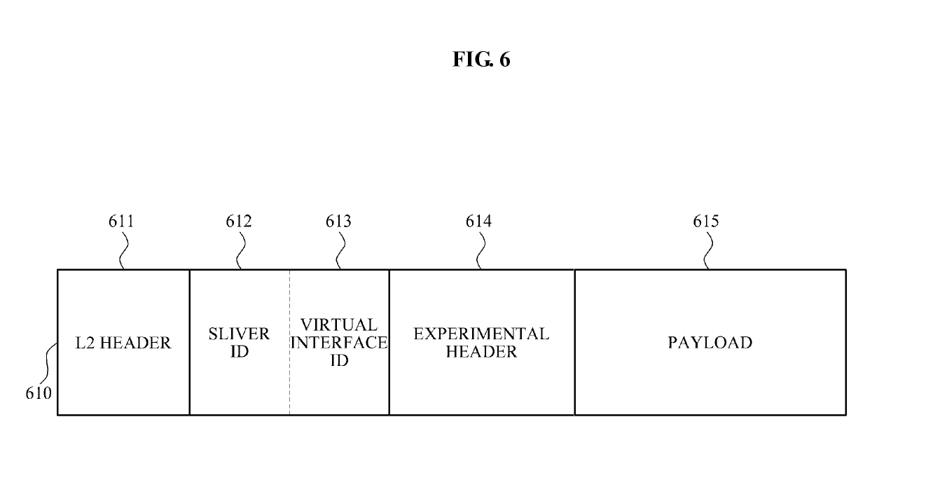

According to the Internet network control method, a packet may be transmitted among the plurality of first layers which are related to the interworking in operation 320. Here, a packet header included in the packet may include the control information. Also, the packet header may include an ID related to the slice of the Internet network. A structure of the packet will be described in further detail with reference to FIG. 6.

FIG. 4 is a diagram illustrating a hierarchical structure of an Internet network according to an embodiment of the present invention.

Referring to FIG. 4, the Internet network according to the present embodiment may include a virtual operator 410 as an uppermost layer. A plurality of the virtual operators 410 may be included.

Each of the virtual operators 410 may include at least one slice 420 as a lower layer.

Each slice 420 may include at least one virtual network 430 as a lower layer. Each virtual network 430 may include a physical network ID (pwid) which is ID information for identifying each physical network.

Each virtual network 430 may include at least one virtual node 440 as a lower layer. Each virtual node 440 may include a physical node ID (pnid) which is ID information for identifying each physical node.

Each virtual node 440 may include at least one sliver 450 as a lower layer.

Each sliver 450 may include at least one virtual interface 460 as a lower layer.

Depending on embodiments, the virtual interface 460 may be a combination of a plurality of virtual interfaces. The virtual interface 460 may include at least one selected from an interface related to a virtual radio, an interface related to a virtual Lamda, an interface related to a virtual link, and an interface related to a socket. The virtual Lamda may be a virtual wavelength.

Depending on embodiments, the virtual interface 460 may include a virtual radio ID (vrid) which is ID information for identifying each virtual radio, a virtual wavelength ID (vwid) which is ID information for identifying each virtual wavelength, a virtual link ID (vlid) which is ID information for identifying each virtual link, a socket ID (skid) which is ID information for identifying each socket, and a physical interface ID (pfid) which is ID information for identifying each physical interface.

Each of the layers in the Internet network may include the ID information for identifying components included therein. More specifically, the virtual operator 410 may include a virtual operator ID (VirOprID) as the ID information for identifying each virtual operator 410. The slice 420 may include a slice ID (SliceID) as the ID information for identifying each slice 420. The virtual network 430 may include a virtual network ID (VirNetID) as the ID information for identifying each virtual network 430. The virtual node 440 may include a virtual node ID (VirNodID) as the ID information for identifying each virtual node 440. The sliver 450 may include a sliver ID (SliverID) as the ID information for identifying each sliver 450. In addition, the virtual interface 460 may include a virtual interface ID (VirIFID) as the ID information for identifying each virtual interface 460.

According to an aspect of the present invention, the virtual operator 410, the slice 420, the virtual network 430, the virtual node 440, the sliver 450, and the virtual interface 460 of the Internet network may be arranged in a different order. For example, the slice 420 may be an uppermost layer in the Internet network while the virtual operator 410 is a lower layer of the slice 420.

In addition, the layers may be physical components rather than the virtual components. For example, the hierarchical structure may include a physical operator, a slice, a physical network, a physical node, a sliver, and a physical interface. Also, the layers may be partially virtual and partially physical.

The Internet network may include a super virtual operator which is an upper layer of the virtual operator 410.

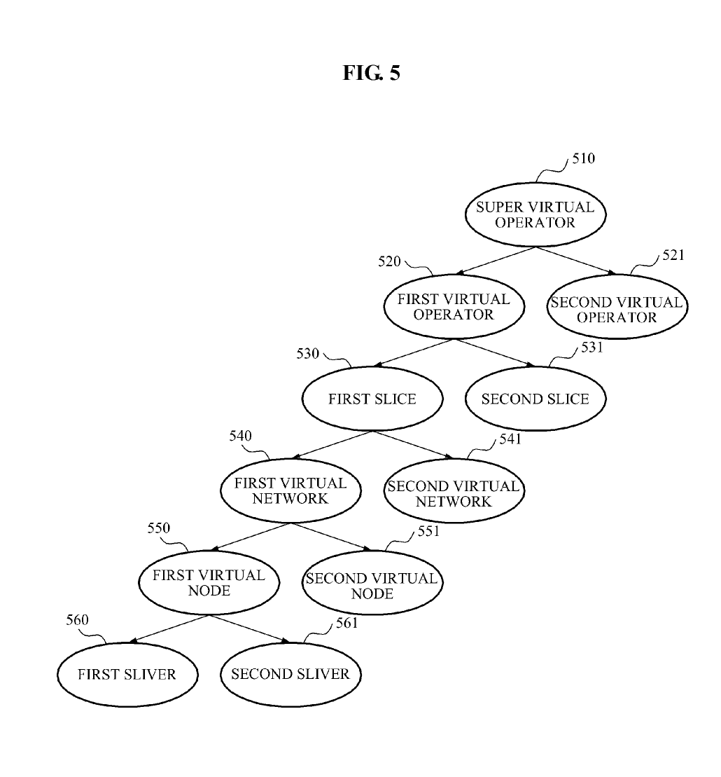

FIG. 5 is a diagram illustrating a hierarchical structure of an Internet network according to another embodiment of the present invention.

Referring to FIG. 5, the Internet network may include a super virtual operator 510 as an uppermost layer. The Internet network may include a virtual operator as a lower layer of the super virtual operator 510, a slice as a lower layer of the virtual operator, a virtual network as a lower layer of the slice, a virtual node as a lower layer of the virtual network, and a sliver as a lower layer of the virtual node.

When an interworking occurs between a first virtual operator 520 and a second virtual operator 521 of the virtual operator layer, the super virtual operator 510 which is the upper layer of the virtual operator may transmit the control information on the first and the second virtual operators 520 and 521 related to the interworking to the first and the second virtual operators 520 and 521. Depending on embodiments, the control information may include VirOprIDs of the first and the second virtual operators 520 and 521.

When an interworking occurs between a first slice 530 and a second slice 531 of the slice layer, the first virtual operator 520 which is the upper layer of the slice may transmit the control information on the first and the second slices 530 and 531 related to the interworking to the first and the second slices 530 and 531. Depending on embodiments, the control information may include SliceIDs of the first and the second slices 530 and 531.

When an interworking occurs between a first virtual network 540 and a second virtual network 541 of the virtual network layer, the first slice 530 which is the upper layer of the virtual network may transmit the control information on the first and the second virtual networks 540 and 541 related to the interworking to the first and the second virtual networks 540 and 541. Depending on embodiments, the control information may include VirNetIDs of the first and the second virtual networks 540 and 541.

When an interworking occurs between a first virtual network 550 and a second virtual node 551, the first virtual network 540 which is the upper layer of the virtual node layer may transmit the control information on the first and the second virtual nodes 550 and 551 related to the interworking to the first and the second virtual nodes 550 and 551. Depending on embodiments, the control information may include VirNodIDs of the first and the second virtual nodes 550 and 551.

In addition, when an interworking occurs between a first sliver 560 and a second sliver 561, the first virtual node 550 which is the upper layer of the sliver layer may transmit the control information on the first and the second slivers 560 and 561 related to the interworking to the first and the second slivers 560 and 561. Depending on embodiments, the control information may include SliverIDs of the first and the second slivers 560 and 561.

FIG. 6 is a diagram illustrating a structure of a conventional packet 610.

Referring to FIG. 6, the conventional packet 610 includes an L2 header 611, a packet header including SliverID 612 and VirIFID 613, an experimental header 614, and a payload 615.

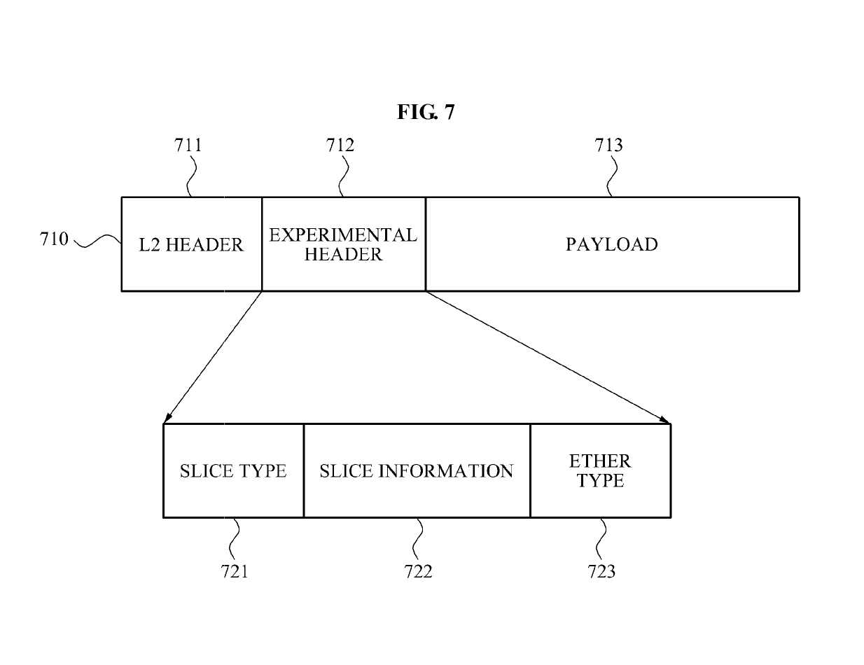

FIG. 7 is a diagram illustrating a structure of a packet 710 according to an embodiment of the present invention.

Referring to FIG. 7, the packet 710 includes an L2 header 711, an experimental header 712, and a payload 713.

The L2 header 711 may include information on a traffic type of the Internet network, for example, OxFFFE[FI].

According to the embodiment, the experimental header 712 may include data fields of a slice type 721, slice information 722, and an ether type 723.

Table 1 shows the slice type 721, and the slice information 722 corresponding to the slice type 721.

TABLE 1

| Slice Type | |
|---|---|
| 721 | Slice Information 722 |
| SliceType(0) | sliceID |
| SliceType(1) | sliverID/virtualIFID |
| SliceType(2) | sliverID/virtualIFID/srcGeoLocID/dstGeoLocID |
| SliceType(3) | sliceID/virNetID/virNodeID/sliverID/virtualIFID |
| SliceType(4) | sliceID/virNetID/virNodeID/sliverID/virtualIFID/geoLocID |
| SliceType(5) | sliceID/virNetID/virNodeID/sliverID/virtualIFID/ |
| | srcGeoLocID/dstGeoLocID |
| SliceType(6) | src(SliceType-4⁺)/dst(SliceType-4⁺) |

Referring to Table 1, SliceType-4+ represents information except for SliceID from a SliceType-4.

The ether type 723 may be allocated with 2 bytes.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method for controlling an Internet network divided into a plurality of layers, the method comprising:
transmitting control information on a plurality of first layers out of the plurality of layers, the first layers related to an interworking, to the plurality of first layers from an upper layer of the first layers when the interworking occurs between the plurality of first layers.

2. The method of claim 1, further comprising transmitting a packet among the plurality of first layers related to the interworking,
wherein a packet header contained in the packet comprises the control information.

3. The method of claim 2, wherein the control information comprises an identifier (ID) related to a slice of the Internet network.

4. The method of claim 1, further comprising transmitting a packet between the plurality of first layers related to the interworking,
wherein an experimental header contained in the packet comprises the control information.

5. The method of claim 4, wherein the control information comprises an ID related to a slice of the Internet network.

6. The method of claim 1, wherein the plurality of layers comprises:
a virtual operator;
a slice;
a virtual network;
a virtual node;
a sliver; and
a virtual interface.

7. The method of claim 6, wherein the virtual interface comprises at least one of an interface related to a virtual radio, an interface related to a virtual Lamda, an interface related to a virtual link, and an interface related to a socket.

8. The method of claim 1, wherein the control information comprises:
an ID related to a virtual operator of the Internet network;
an ID related to a slice of the Internet network;
an ID related to a virtual network of the Internet network;
an ID related to a virtual node of the Internet network;
an ID related to a sliver of the Internet network; and
an ID related to a virtual interface of the Internet network.

9. The method of claim 2, wherein
the packet further comprises an experimental header,
the packet header comprises an ID related to a slice of the Internet network; and
the experimental header comprises:
an ID related to a virtual operator of the Internet network;
an ID related to a slice of the Internet network;
an ID related to a virtual network of the Internet network;
an ID related to a virtual node of the Internet network;
an ID related to a sliver of the Internet network; and
an ID related to a virtual interface of the Internet network.

10. The method of claim 9, wherein the packet further comprises an L2 header, the L2 header comprising information on an ID contained in the packet.

11. A method for transmitting a packet in an Internet network, comprising:
inputting an ID related to a slice of the Internet network to a packet header of the packet.
